(19) United States
(12) Patent Application Publication
(10) Pub. No.: US 2007/0082654 A1
(43) Pub. Date: Apr. 12, 2007

(54) System to extend service, expand access and protect user data across wireless networks

(75) Inventors: Shant Hovnanian, New York, NY (US); Marcos R. Lara, New York, NY (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Speedus Corp., New York, NY (US)

(21) Appl. No.: 11/245,545

(22) Filed: Oct. 7, 2005

(51) Int. Cl. H04M 3/16

(52) U.S. Cl. 455/410

(57) ABSTRACT

A system, method and apparatus for more easily managing secure access to local area net works, so that a member of a community of trusted users is able to have secure, accountable access to the Internet from either their own, home, wireless access point or while roaming via other community-affiliated wireless access points. A communications module running on the wireless device manages the access using an access key that may be determined by a combination of the network name and a community identifier. The communications manager may hide this ability to access the Internet from the user while performing further security checks. Based on whether the user is at home or roaming, the user may be given different access permission such as different levels of quality of service, including different levels of bandwidth throttling.

### FIELD OF THE INVENTION

The present invention relates to methods and systems for providing wireless access to communications networks, and more particularly to methods and systems for providing secure, managed wireless access to the Internet.

### BACKGROUND OF THE INVENTION

WiFi is reshaping the way people go online by allowing them to access high-speed Internet connections at home, and in many public places, from suitably equipped laptop and portable computers. WiFi, the informal name for the Institute of Electrical and Electronics Engineers (IEEE) 802.11a/b/g standards for wireless local area networks (WLANs), is already available in over 17 million homes and small offices in the USA. Moreover, the number of WiFi network access points is expected to double over the next 4 years.

Although there are many benefits to WiFi access to broadband internet services, there are drawbacks. One particular concern is that the majority of WiFi access points are insecure, allowing access to any WiFi equipped laptop within range of the access point, which is typically about 100 meters. Although WiFi cards do have a unique identification number and encryption options, the majority of users do not turn on the encryption because of the added setup complexity. And the unique hardware identifiers are typically discarded by most consumer routers.

As a result of this lack of security, misuse of these open networks is also growing rapidly. A criminal with a WiFi equipped laptop can, for instance, cruise around a suburban neighborhood, or city block, surreptitiously using the open high-speed Internet access to carry out their illegal activities with a very low risk of being caught. Law enforcement agencies can only track their activities back to the Internet Protocol (IP) address corresponding to the access point that was used but, if that access point is a public network, the trail goes cold. Similarly, if the address leads to an unsecured home WiFi network, the enforcement agencies are left with an innocent owner of the access point and have no way of locating the criminals.

What is needed is a simple way to make WiFi encryption easy to set up for a naïive user, preferably in a way that provides security and accountability while preserving the benefits of roaming access for honest users.

### SUMMARY OF THE INVENTION

Briefly described, the invention provides a system, method and apparatus for more easily managing secure access to local area net works.

In a preferred embodiment of the present invention, a member of a community of trusted users is able to have secure, accountable access to the Internet from either their own, home, wireless access point or while roaming. The secure and accountable roaming access is provided by other community-affiliated wireless access points.

In a preferred embodiment, a communications module running on the portable, wireless device attempting to obtain access to the Internet, manages the access.

A wireless access point affiliated with the community of trusted users is setup to be secure by having an access key that is determined by a combination of the network name and a community identifier.

The communications module, or an associate security module, already knows the community identifier and obtains the network name from the access point. The communications module also knows how the community identifier and the network name combine to provide the access key. The communications module is, therefore, able to generate the access key and so obtain access to the Internet via the secure access point.

In a preferred embodiment of the invention, the communications manager hides this ability to access the Internet from the user while performing further security checks. These further security checks may include sending a user name and password to a community server for identification. In addition, the communications manager may send a unique hardware identifier associated with the access point to the community server. The community server may use pre-loaded databases to determine if the user identification and password match. The community server may also use the access point hardware identifier to determine whether the user is connecting to their own, home, access point, or is roaming. Based on whether the user is at home or roaming, the user may be given different access permission such as, but not limited to, a different level of quality of service, including a different level of bandwidth throttling.

These and other features of the invention will be more fully understood by references to the following drawings.

### BRIEF DESCRIPTION OF THE DRAWINGS

FIG. 1 is a schematic overview of wireless local area networks connected via a wired network.

FIG. 2 is a flow-diagram showing the management of wireless Internet access in accordance with a preferred embodiment of the present invention.

FIG. 3 is a flow-diagram showing setup of a wireless Internet access management system in accordance with a preferred embodiment of the present invention.

FIG. 4 is a schematic drawing showing a user interface for a connection manager.

FIG. 5 is a flow diagram showing the steps taken in establishing a virtual private network via a non-broadcast network name.

### DETAILED DESCRIPTION

The present invention applies to the management of wireless Internet access, and, in particular, to a system, method and apparatus for providing secure Internet access to one or more members of a community via wireless access points affiliated with the community.

In a preferred embodiment of the present invention, AAA secure access, i.e., access that requires authorization, authentication and accountability, is provided on local area a network such as, but not limited to, a WiFi access point, to all members of a predefined, trusted community.

In a preferred embodiment, the connection manager, a software module running on a wireless device seeking access to the Internet via a wireless access point, manages the access. The connection manager, or an associated security software module, contains a community identifier that may be, but is not limited to, an alpha-numeric key.

The wireless access point typically has a unique hardware identifier such as, but not limited to, the Media Access Control (MAC) address that uniquely identifies each node in a network, usually by means of a twelve-digit number. The wireless access point also has a network name such as, but not limited to, the 32-character service set identifier (SSID). In a preferred embodiment, a wireless access point also has an access key such as, but not limited to a wired equivalent protection (WEP) encryption key. For access points belonging to members of the community of trusted users, this access key is generated by combining the network name, the community key and optionally the unique hardware identifier, in a predetermined manner such as, but not limited to, a proprietary one-way hash function.

A wireless device such as, but not limited to, a laptop computer, can obtain the network name and the hardware identifier as they are typically broadcast by the access point. If the wireless device is running the connection manager, which is distributed to members of the trusted community, it may then determine if the access point is affiliated with the community. The connection manager does this by, for instance, combining the network name, the hardware identifier and the community key in the same predetermined manner as was used in setting up the affiliated access point. If the correct access key is generated, the connection manager can establish an association with the access point, and the user can use their portable computing device to surf the Internet using the access point.

In a preferred embodiment of the invention, this Internet access ability is hidden from the user until a further level of security has been achieved. In particular, the Internet access is maintained behind a firewall by the communications manager, while the communications manager sends a user identifier and a password to a community server. If the user identifier and password match, a user identity is authenticated by the community server. This user identity may come with certain user authorizations. In particular, the community server may obtain the hardware identifier of the access point to determine if the user is at their home access point or if they are roaming and obtaining access via an access point belonging to another member of the community. If the user is on their home access point, their use of the Internet may be unlimited. If, however, the user is surfing the Internet via an access point belonging to another member of the community, their access may have various quality-of-service parameters set by, for instance, having their bandwidth use reduced, or throttled, so that the impact on the home user's Internet service is kept to an acceptable limit. For instance, the roaming user, or users, may only be allowed to use some preset percentage of the available bandwidth such as, but not limited to, 10 percent of the available bandwidth.

A preferred embodiment of the invention will now be described with reference to the accompanying figures in which, as far as possible, like numbers indicate like elements.

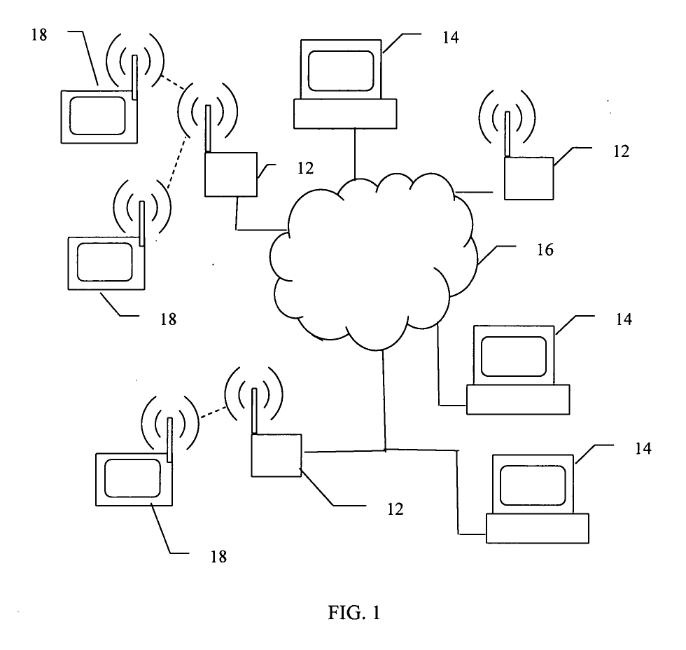

FIG. 1 is a schematic overview of a number of wireless local area networks connected via a wired network, in which one or more wireless devices 18 each access a wireless access point 12. The wireless access points 12 may be directly connected to a network 16 or may be connected to wired computers 14. The wireless devices 18 may be, but are not limited to, wireless enabled laptops, wireless enabled personal digital assistants (PDA's) or wireless telephones. The wireless connection may be made by means of one of the Institute of Electrical and Electronics Engineers (IEEE) 802.11 standards for wireless local area networks (WLANs) including, but not limited to the 802.11a, 802.11b or 802.11g standards, commonly referred to as WiFi, or some combination thereof. The wireless connection may also be or be based on, but is not limited to, the well known Blue Tooth wireless protocol or the IEEE 802.16 standard known as WiMAX, or some combination thereof with each other or the WiFi standards.

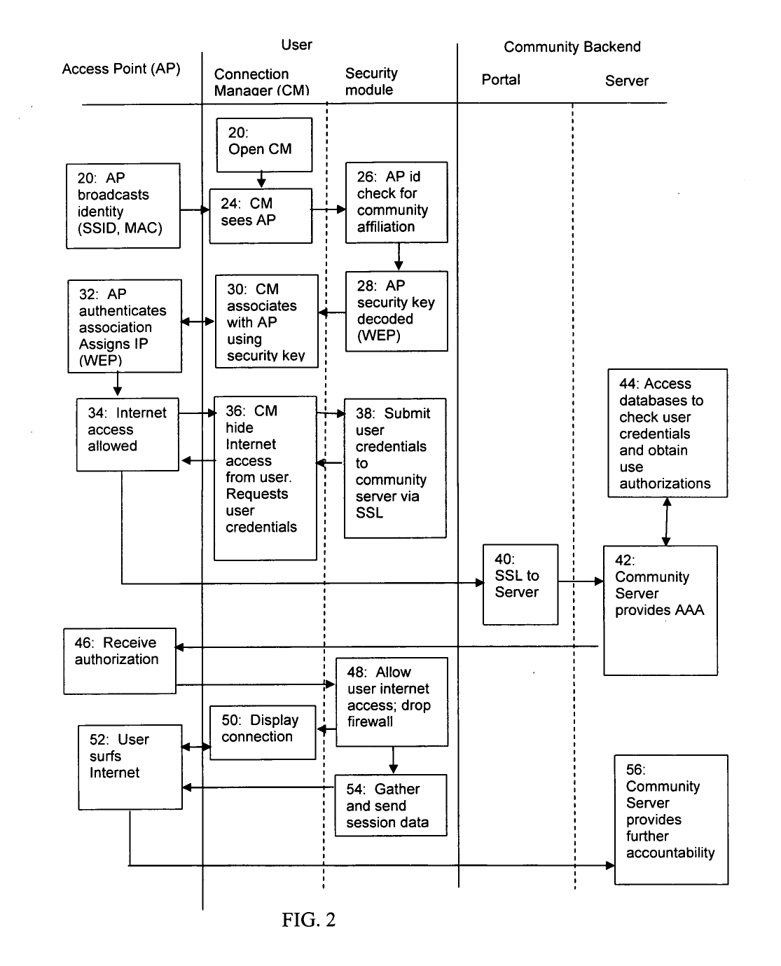

FIG. 2 is a flow-diagram showing the management of wireless Internet access in accordance with a preferred embodiment of the present invention.

In step 20 a user opens the connection manager. The connection manager may be a software module running on a wireless, portable computing device 18.

In step 22 a wireless access point identifies itself by broadcasting its network name and its unique hardware identifier. In a WiFi system, the network name is the SSID and the unique hardware identifier is the MAC, both of which are described above in detail. A WiFi system typically broadcasts on one of 14 channels available in the 2.4 GHz band, as specified by the appropriate IEEE specification. Only 11 of these channels can be used in the U.S. because of FCC regulations, and only three of them are non-overlapping channels.

In step 24, the connection manager obtains the network name and the unique hardware identifier, i.e. in a preferred embodiment, the access point's SSID and MAC address.

In step 26, the connection manager relays the network name and the unique hardware identifier to a local community security module running on the same portable, wireless device as the connection manager. The local community security module may be a separate software module or it may be an integral subsystem of the connection manager software module. The local community security module is typically pre-programmed with a community identifier. The community identifier may, for instance, be an alpha-numeric string or it may be an algorithm that relates two or more or the access point's broadcast attributes in unique, identifiable way. In one embodiment of the invention, an access point affiliated with the community is setup so that the network name is formed as a combination of the unique hardware identifier and the community identifier. For instance, the network name may be the sum of a community identifier that is an alpha-numeric string, and the unique hardware number. In such a system, the local community security module may identify whether or not an access point is affiliated with the community by performing the appropriate comparison of the network name, the unique hardware identifier and the community identifier.

In step 28, the community security module decodes the access point's security key. In a preferred embodiment of the present invention, the security key is a WEP key that obtained or discovered by the communications manager, or its associated security module, by combining the network name with the community identifier. In a further preferred embodiment, the security key may be discovered by combining the network name with the unique hardware identifier and the community identifier. In a further embodiment there is a second community identifier, which may be a second algorithm, such that the security key is obtained by running that second algorithm on the network name, the access point identifier, or any broadcast attribute of the access point such as, but not limited to the channel number, the broadcast frequency, or the beacon interval, or any combination thereof.

In step 30 the connection manager establishes a connection by associating with the access point using, for instance, the appropriate WiFi synchronization protocols and the discovered WEP key.

In step 32 the access point authenticates the association and assigns an IP address for Internet access.

In step 36 the connection manager hides the connected state from the user, i.e. the connection manager effectively firewalls the user from the Internet. At the same time the connection manager requests the user credentials from the local community security module. The user credentials may be, but are not limited to, a user ID such as a name or an email address and an associated password.

In step 38 the local community security module submits the user credentials to the community server using appropriate encryption such as, but not limited to, a secure socket layer (SSL). The community server is typically accessed via a community portal.

In step 40 the community portal establishes an SSL connection from the connection manager to the community server.

In step 42 the community sever performs AAA authorization by accessing databases in step 44. In a preferred embodiment, the user name and password may be authenticated by checking against a master list of community names and passwords to check that they correspond. A check may then be made on what services that user is authorized to access. This authorization may, for instance, take the form of checking the MAC address of the access point to see if it is the home access point of the user. If it is the user's home access point, they may then be authorized full access, i.e., to use as much available bandwidth and to have highest priority to that bandwidth. If, however, it is not the user's home access point, the roaming access authorization may restrict the user to, for instance, only being allowed to use a percentage of the available bandwidth of the access point.

In step 46, if the authentication of the user is successful, the community server sends the authorization to the access point, which then passes it on to the community security module.

In step 48, the community security module then allows the user the appropriate level of access including, if appropriate, dropping the firewall.

In step 50, the connection manager displays the connection to the user.

In step 52, the user surfs the Internet using the access point with the appropriate quality-of-service provided.

In step 54, the security module gathers session data, including data such as, but not limited to, the time the session started. This session data may then be sent via the access point to the community server so that the accountability function of the authorization can be done in step 56 by, for instance, updating the database records and logs regarding the activity of the access point, the activities of the portable device and the activities of the user.

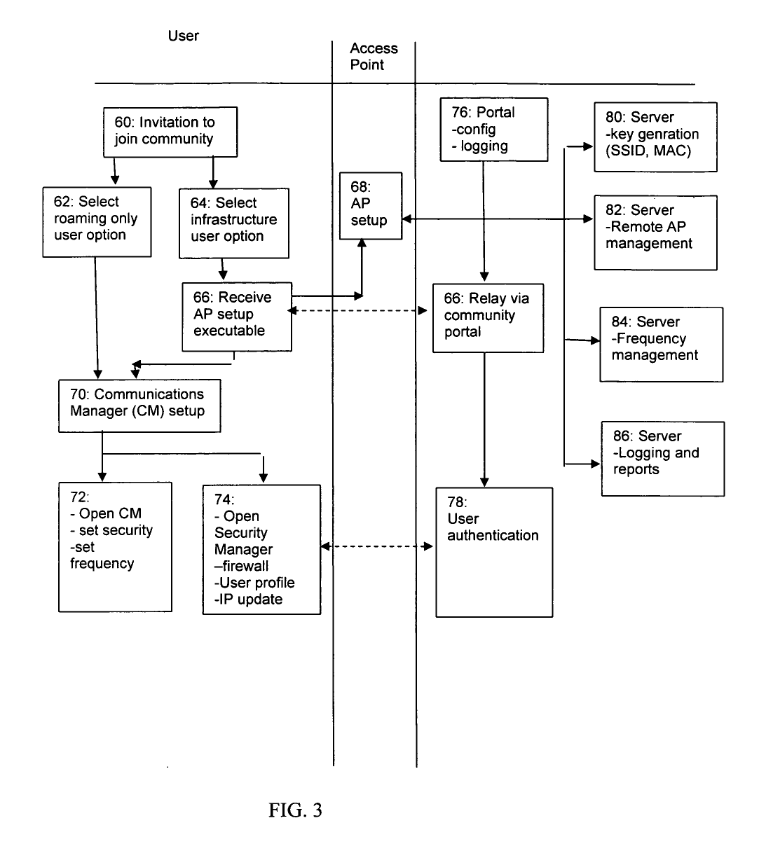

FIG. 3 is a flow-diagram showing setup of a wireless Internet access management system in accordance with a preferred embodiment of the present invention.

In step 60 a new user receives an invitation to join the selected community.

In step 62, the new user elects to join as a roaming new user, i.e., a user that does not have their own wireless access point. Joining as a roaming user may entail membership fees that differ from that of an infrastructure new user to compensate, in part, for not contributing any access to other members of the community. Joining as a roaming user may also entail providing additional identification such as, but not limited to, credit card information, drivers license information or bank account information.

In step 64 the user may elect to join as an infrastructure new user, i.e., a member of the community having their own access point.

If the user joins as an infrastructure user, then in step 66, an access point setup module is downloaded from the community server, and forwarded to the access point. In step 68, the access point then communicates with the community server to set up the access point to conform to community requirements such as, but not limited, correct key generation.

Both roaming and infrastructure new users proceed to step 70 in which the communications module is setup.

In step 72 the communications module is opened, the security is enabled and the frequency set.

In step 74 the security module of the communications manager is activated, the firewall setup, a user profile and an updated IP address exchanged with the community portal.

The community portal, which is configured and begins logging activity in step 76, may perform user authentication in step 78.

The community portal is set up to perform key generation in step 80, remote access point management in step 82, server frequency management in step 84 and server logging and reporting in step 86.

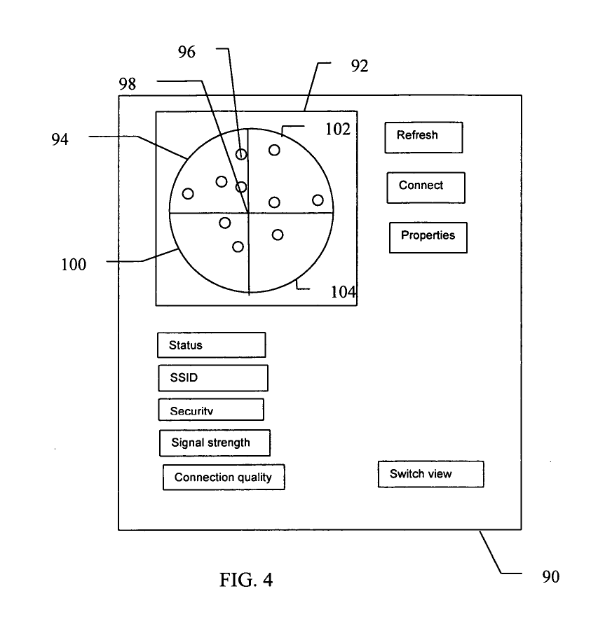

FIG. 4 is a schematic drawing showing a user interface 90 for a connection manager. The user interface 90 includes an access point locator 92, which may take the form of a circle divided into quadrants, each of which represents access points having different security levels. The availability of access points may be indicated by indicia 96 within the quadrants. In a preferred embodiment, a first quadrant 94 may be indicative of in-range access points having no security, a second quadrant 100 may be indicative of access points having a first type of security such as, but not limited to, a wired equivalent protocol, WEP, a third quadrant 102 may be indicative of access points have a second type of security such as, but not limited to, wireless accountable protocol, WAP, and a forth quadrant 104 may be indicative of access points have secure, community affiliated access. In a preferred embodiment, the position of the indicia within the quadrant may be indicative of the access point's strength and frequency. For instance, the distance between the indica 96 and the center of the circle 98 may be indicative of that access points relative signal strength. The radial position of the indicia 96 within quadrant 94 may be indicative of the frequency on which the access point is broadcasting or operating, so that co-radial access points are broadcasting or operating on the same frequency.

The user interface 90 may further include buttons and labels allowing actions such as refresh, connect, properties or switch view to be made.

For instance, the refresh button may update the evaluation of what access points are currently available and their relative or absolute signal strength.

The connect button may, for instance, connect the user to a currently high lighted access point.

The properties button may, for instance, cause the properties of a currently highlighted access point to be displayed.

The switch view button may, for instance, cause the view of available access points to switch to being a more conventional list of access point names, encryption type and signal strength.

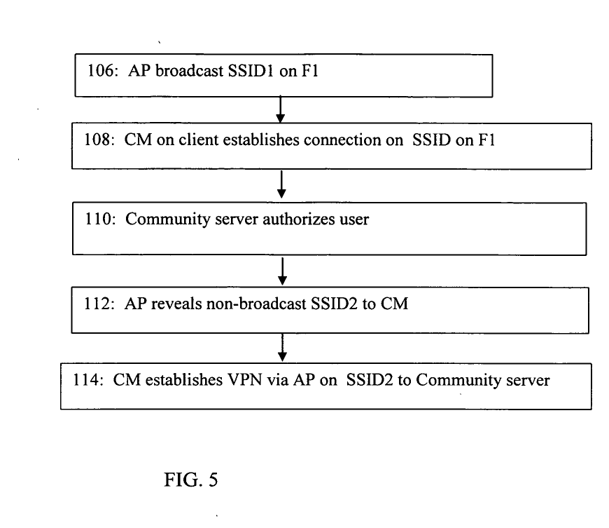

FIG. 5 is a flow diagram showing the steps taken in establishing a virtual private network via a non-broadcast network name.

In step 106, the access point may broadcast a first network name, which may be an SSID1 and an associated access point identifier, which may be a MAC address, on a first frequency F1.

In step 108, a connection manager running on a mobile client establishes a connection using the first network name, SSID1, and the first frequency F1. If the first user name SSID1 and the access point identifier, MAC, are indicative of the access point being associated with a community that the client has secure access to, the connection manager may obtain the encryption key, typically a WEP key.

As described above, in an access point associated with the community, the community name (SSID1) is related to the hardware identifier by a community identifier, which may be an algorithm, known to the community server and to the connection manager. SSID1 will therefore have been setup on the access point so that it is the product of subjecting the access point identifier (MAC) to the community identifier algorithm. The connection manager running on the mobile client obtains both the access point identifier (MAC) and the network name (SSID1) of the access point. The connection manager knows community identifier algorithm and runs it on the access point identifier. If this results in the network name, the connection manager identifies the access point as being associated with the community. Although this example uses the network name and the access point identifier, the algorithm could instead, or in addition, rely on any other information that is broadcast by the access point such as, but not limited to, the channel frequency and the beacon interval, i.e., the frequency with which the information is broadcast.

Having identified the access point as associated with the community, the connection manager may then obtain the access key by, for instance running a community access key algorithm on one or more of the access points broadcast attributes such as, but not limited to, the network name (SSID1), the access point hardware identifier (MAC), the channel number, the frequency, or the beacon interval, or any suitable combination thereof.

Having established a secure connection in step 108 using the broadcast network name on the broadcast frequency and the discovery access key, user and password information may be sent to the community server so that, in step 110, the community server may authorize the user. The authorization of the user may include looking up user name and password in a secure data base.

In step 112, the information the user has been authorized may be sent to the access point, at which time the access point reveals a non-broadcast network name to connection manager. The access point may also reveal an access key and channel to use with this non-broadcast network name or these may be inferred by the connection manager using the community access key algorithm or any other suitable pre-stored algorithm.

In step 114, the communications manager may then establish a virtual private network to the community server using the non-broadcast network name and its associated access key and broadcast frequency. In this way, the communications can proceed over an access point that is secure and using a frequency and a network name not generally broadcast.

In a further embodiment, the access may include dynamic frequency selection to minimize congestion. This may, for instance, be done by the communications manager sending details on local traffic to the community server in step 108, so that in step 110 the community server, in authorizing access, may additionally send a broadcast name that does has the lowest local traffic. For instance, the access point may have three different non-broadcast names, each set up to operate on one of the three non-overlapping channels or frequencies. The non-broadcast name associated with the least used channel reported locally may therefore be selected on which to establish the VPN.

In further embodiments the client isolation using Virtual Private Networks (VPN—laptop to community server) and virtual local area networks (VLAN) may also be setup for access points using ether the broadcast or non-broadcast names.

In a further embodiment of the invention, an access point may have a further client-side communications module running on, for instance, the access points wireless router, that includes the ability to isolate client traffic, segment wired traffic from wireless traffic, and with the ability to selectively bridge between wired and wireless connections. In such an embodiment, the client-side communications module may, for instance, allow a user identified as being a home user to access peripherals such as, but not limited to, printers, hard drives, CD and DVD ROM drives and burners, monitors and screens for the purpose of obtaining, storing or displaying data. A user identified as being a roaming user may not have access to these peripheral devices.

The client-side communications module may further be capable of setting bandwidth throttling and the quality of services, including network resources, for each VLAN separately.

In a further embodiment, all access to any community associated access point may be monitored by appropriate data including, but not limited to access time, user identity, traffic volume, URL's of sites visited, e-mail addresses of e-mail sent or re-laid, being sent to the community server for storage and/ or analysis.

In a further embodiment, the connection monitor may include an expert system to assist in selection of the best connections. The expert system may include an mythology such as, but not limited to, first detecting all the open or available connections, The open or available connections may then be weighted by factors such as, but not limited to, signal strength, bandwidth and channel congestion, or some combination thereof. The selection may also be made by first ordering the open or available access points by signal strength, then least congested channel, then whether or not it has a valid IP and then by the bandwidth/speed base on a measured ping time.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

What is claimed is:

1. A method of managing internet access, said method comprising the steps of: providing a communications manager module, running on a wireless enabled device;
receiving, by said communications manager module, one or more broadcast variables from a wireless access point, affiliated to said community;
determining, by said communications manager module, an access key to said wireless access point, using said one or more broadcast variables.

2. The method of claim 1 wherein said communication manager module further comprises a common community identifier; wherein said wireless access point further comprises a selected privately operated internet wireless access point; wherein said one or more broadcast variables comprise a unique hardware identifier of said wireless access point, and a network name; and wherein determining an access key further comprises combining said hardware identifier and said common community identifier.

3. The method of claim 1 further comprising establishing, by said communications manager running on said wireless enabled device and using said wireless access point, a user identity at a community server.

4. The method of claim 3 further comprising receiving, by said communications manager running on said wireless enabled device, a user authorization from said community server.

5. The method of claim 4 wherein said secure wireless access point further comprises a unique hardware identifier supplied to said community server by said communications manager running on said wireless enabled device; and wherein said user authorization is one of a roving user and a home user, based in part on said unique hardware identifier.

6. The method of claim 5 further comprising setting, by said communications manager running on said wireless enabled device, a quality of service.

7. The method of claim 6 wherein said setting a quality of service comprises bandwidth throttling when said user authorization corresponds to said roving user.

8. The method of claim 7 further comprising gathering, by said communications manager, a spectrum congestion level; and resetting a broadcast frequency of said wireless access point to a least congested channel determined using said spectrum congestion level.

9. A system of managing internet access, said method comprising:
a communications manager module, running on a wireless enabled device;
a wireless access point, affiliated to said community;
one or more variables broadcast by said wireless access point and received by said communications manager module;
an access key to said wireless access point, said access key being determined by said communications manager module using said one or more broadcast variables.

10. The system of claim 9 wherein said communication manager module further comprises a common community identifier; wherein said wireless access point further comprises a selected privately operated internet wireless access point; wherein said one or more broadcast variables comprise a unique hardware identifier of said wireless access point, and a network name; and wherein said access key is determined by combining said hardware identifier and said common community identifier.

11. The system of claim 9 further comprising a user identity at a community server, said user identity being established by said communications manager running on said wireless enabled device and using said wireless access point.

12. The system of claim 11 further comprising a user authorization, received from said community server by said communications manager running on said wireless enabled device.

13. The system of claim 12 wherein said secure wireless access point further comprises a unique hardware identifier supplied to said community server by said communications manager running on said wireless enabled device; and wherein said user authorization is one of a roving user and a home user, based in part on said unique hardware identifier.

14. The system of claim 13 further comprising a quality of service, said quality of service set by said communications manager running on said wireless enabled device.

15. The system of claim 14 wherein said setting a quality of service comprises bandwidth throttling when said user authorization corresponds to said roving user.

16. The system of claim 15 further comprising a spectrum congestion level, gathered by said communications manager; and wherein a broadcast frequency of said wireless access point is reset to a least congested channel, as determined using said spectrum congestion level.
